(19) United States
(12) Patent Application Publication
(10) Pub. No.: US 2026/0104522 A1
(43) Pub. Date: Apr. 16, 2026

(54) GENERATING UNCERTAINTY FOR SEISMIC SURFACES

(71) Applicant: Schlumberger Technology Corporation, Sugar Land, TX (US)

(72) Inventors: Dirk Gunnar Steckhan, Stavanger (NO); Nestor Herman Cuevas, Tananger (NO)

(21) Appl. No.: 18/916,903

(22) Filed: Oct. 16, 2024

(51) Int. Cl. G01V 1/30; E21B 49/00; E21B 7/04

(52) U.S. Cl. CPC G01V 1/30; E21B 49/00; E21B 7/04

(57) ABSTRACT

A seismic surface uncertainty system may receive a seismic surface and seismic data used to generate the seismic surface, the seismic data including a plurality of seismic traces having a plurality of waveforms, the seismic surface intersecting each of the plurality of seismic traces, the plurality of seismic traces including a first seismic trace and a set of seismic traces, the set of seismic traces including each seismic trace located within an uncertainty radius of the first seismic trace. A seismic surface uncertainty system may identify a plurality of lags between the first seismic trace of the plurality of seismic traces and each seismic trace of the set of seismic traces. A seismic surface uncertainty system may, based on the plurality of lags, generating an uncertainty for the seismic surface at the first seismic trace of the plurality of seismic traces.

### BACKGROUND

Many natural resources are accessible located underground. Such natural resources include water reservoirs and hydrocarbon reservoirs such as natural gas and oil. To access these natural resources, downhole drilling systems may drill a wellbore along a trajectory to a target location, formation, or geological feature. To assist in the planning of the trajectory of the wellbore, a drilling system may prepare simulations and projections of geological features. The simulations and projections of geological features may be based on seismic data collected during exploration and drilling operations.

### SUMMARY

In some aspects, the techniques described herein relate to a method for seismic uncertainty generation. A seismic surface uncertainty system receives a seismic surface and seismic data used to generate the seismic surface. The seismic data includes a plurality of seismic traces having a plurality of waveforms. The seismic surface intersects each of the plurality of seismic traces. The plurality of seismic traces includes a first seismic trace and a set of seismic traces. The set of seismic traces includes each seismic trace located within an uncertainty radius of the first seismic trace. The seismic surface uncertainty system identifies a plurality of lags between the first seismic trace of the plurality of seismic traces and each seismic trace of the set of seismic traces. Based on the plurality of lags, the seismic surface uncertainty system generates an uncertainty for the seismic surface at the first seismic trace of the plurality of seismic traces.

In some aspects, the techniques described herein relate to a method for seismic uncertainty generation. A seismic surface uncertainty system generates a seismic surface from seismic data. The seismic data includes a plurality of seismic traces having a plurality of waveforms. The seismic surface intersects each of the plurality of seismic traces at the plurality of waveforms. For each seismic trace of the plurality of seismic traces, the seismic surface uncertainty system identifies a plurality of lags between each seismic trace of the plurality of seismic traces and a set of seismic traces of the plurality of seismic traces. For each seismic trace of the plurality of seismic traces, the seismic surface uncertainty system generates an uncertainty for the seismic surface based on the plurality of lags.

This summary is provided to introduce a selection of concepts that are further described in the detailed description. This summary is not intended to identify key or essential features of the claimed subject matter, nor is it intended to be used as an aid in limiting the scope of the claimed subject matter. Additional features and aspects of embodiments of the disclosure will be set forth herein, and in part will be obvious from the description, or may be learned by the practice of such embodiments.

### BRIEF DESCRIPTION OF THE DRAWINGS

In order to describe the manner in which the above-recited and other features of the disclosure can be obtained, a more particular description will be rendered by reference to specific embodiments thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example embodiments, the embodiments will be described and explained with additional specificity and detail through the use of the accompanying drawings in which:

FIG. 1 is a representation of a drilling system, according to at least one embodiment of the present disclosure.

FIG. 2 is a representation of a seismic surface uncertainty system, according to at least one embodiment of the present disclosure.

FIG. 3 is a representation of a seismic surface uncertainty system, according to at least one embodiment of the present disclosure.

FIG. 4-1 through FIG. 4-4 are representations of the determination of uncertainty in a seismic surface, according to at least one embodiment of the present disclosure.

FIG. 5 is a representation of a seismic plot of a seismic surface, according to at least one embodiment of the present disclosure.

FIG. 6 is a flowchart of a method for seismic surface uncertainty generation, according to at least one embodiment of the present disclosure.

FIG. 7 is a flowchart of a method for seismic surface uncertainty generation, according to at least one embodiment of the present disclosure.

FIG. 8 is a representation of a computing system, according to at least one embodiment of the present disclosure.

### DETAILED DESCRIPTION

This disclosure generally relates to devices, systems, and methods for determining the uncertainty in a seismic surface. Seismic surfaces are generated by interpreting seismic data to identify the location of reflecting surfaces of an underground formation. Conventionally, the seismic surface generation systems present the generated seismic surface as definite. This may result in a false sense of security because the interpretation of the subsurface performed on seismic data is never completely exact as there are uncertainties involved. For example, the seismic data in depth may be a rough estimate where the depth conversion is itself based on interpretations of the seismic signal. Furthermore, the resolution of the seismic surface depends on the seismic signal, with the surface location only as precise as the resolution. There are further uncertainties on how to place an interpretation of a surface because it may not be clear that the edge in the image is the boundary of the actual object. In addition, the interpretation process itself may result in general errors and inconsistencies. All these uncertainties add up and should be taken into consideration when basing decisions on a subsurface interpretation. Such uncertainty in the location of the seismic surface may reduce the confidence of the location of a wellbore. A drill planner or operator may make operational decisions based on the presumably definite seismic surface, which may result in a wellbore or drilling system intersecting an undesirable formation or geological area.

In accordance with at least one embodiment of the present disclosure, a seismic surface uncertainty generator may estimate the uncertainty of the location of a seismic surface based on the lag between seismic traces. The lag between seismic traces may be representative of the difference in location of the seismic surface with respect to the waveform of the seismic trace. A greater lag is associated with a greater uncertainty, and a smaller lag is associated with a smaller uncertainty. The seismic surface uncertainty generator may identify a set of seismic traces within an uncertainty radius of a target seismic trace. The seismic surface uncertainty generator may identify the lag between each of the seismic traces of the set. The uncertainty of the target seismic trace may be based on the lags of the seismic traces of the set. The uncertainty of the seismic surface may be determined by identifying the uncertainty for each seismic trace of the seismic data. In this manner, an operator may make drilling decisions based not only on the seismic surface, but the uncertainty in generating the seismic surface.

As illustrated by the foregoing discussion, the present disclosure utilizes a variety of terms to describe features and advantages of the seismic surface uncertainty system. Additional detail is now provided regarding the meaning of such terms. For example, as used herein, the term “seismic surface” refers to a rendering of a geologic feature based on the interpretation of seismic data. In particular, the term “seismic surface” can include a 2-dimensional or 3-dimensional rendering of the geological feature.

As used herein, “seismic data” may refer to data collected from a seismic sensor from a seismic source. For example, seismic data may include a waveform measured by the movement of the ground at the seismic sensor. Seismic data may include an interpretation of the seismic wave collected at the seismic sensor. For example, the seismic data my include an interpretation of the location of particular geologic features (including geologic features that reflect seismic waves), the depth of particular geologic features, and a type of geologic feature. Seismic data may be collected in a volume called a seismic volume. The volume may include seismic cubes that include an interpretation of the geologic feature within the volume. The seismic volume may be formed as a result of a 3-dimensional grid of seismic traces.

As used herein, a “seismic trace” (also called a seismic wiggle) may be a portion of a seismic waveform that represents a change in a geologic feature. Seismic traces having similar patterns may be correlated to identify common geologic features. A group of seismic traces that have similar patterns may be used to generate a seismic surface.

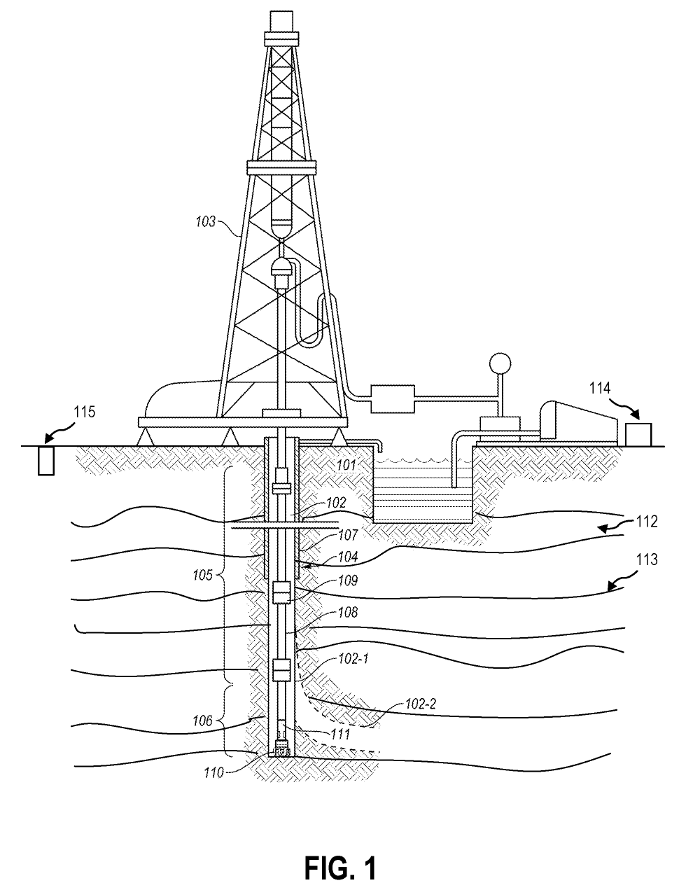

By way of background, FIG. 1 shows one example of a drilling system 100 for drilling an earth formation 101 to form a wellbore 102. The drilling system 100 includes a drill rig 103 used to turn a drilling tool assembly 104 which extends downward into the wellbore 102. The drilling tool assembly 104 may include a drill string 105, a bottomhole assembly (BHA) 106, and a bit 110, attached to the downhole end of drill string 105.

The earth formation 101 may include strata 112, or layers of rock. The strata 112 may include an unconformity 113 between individual layers of the earth formation 101. The unconformity 113 may result in a change in rock properties. Such changes in rock properties may result in a change in the propagation of seismic waves through the earth formation 101. For example, an unconformity 113 may be a reflector, and may reflect the seismic waves. The resulting reflected seismic waves may be used to identify the unconformity 113 separating two strata 112.

The drilling system 100 may include a seismic sensor 114. The seismic sensor 114 may detect seismic waves generated by a seismic source 115. The seismic source 115 may include any device capable of generating seismic waves, such as an explosive charge, a hammer, a hammer, a vibrator, an air gun, a water jet, any other seismic source, and combinations thereof. The seismic source 115 and/or the seismic sensor 114 may be located at any location, including at the surface and/or at a depth underground. In some embodiments, the seismic source 115 may be located in the wellbore 102. When actuated, the seismic source 115 may cause vibrations to travel through the earth formation 101. At least a portion of the vibrations may be reflected at an unconformity 113 between two strata 112. The seismic sensor 114 may measure the reflected waveform to generate seismic data. The seismic data may be converted to physical datapoints in any manner, including through calculations such as an inversion function.

In accordance with at least one embodiment of the present disclosure, a seismic surface generation system may generate a seismic surface of the strata 112 using the seismic data collected by the seismic sensor 114. The seismic surface may be a three-dimensional representation of the strata 112, including the unconformities 113 separating the strata 112.

As discussed herein, a seismic surface generator may generate a seismic surface of one or more of the strata 112, typically as represented by the unconformity 113 between two strata 112. A seismic surface uncertainty generator may determine an uncertainty for the generated seismic surface, based on a comparison of the lag with surrounding seismic traces.

The drill string 105 may include several joints of drill pipe 108 connected end-to-end through tool joints 109. The drill string 105 transmits drilling fluid through a central bore and transmits rotational power from the drill rig 103 to the BHA 106. In some embodiments, the drill string 105 may further include additional components such as subs, pup joints, etc. The drill pipe 108 provides a hydraulic passage through which drilling fluid is pumped from the surface. The drilling fluid discharges through nozzles, jets, or other orifices in the bit 110 for the purposes of cooling the bit 110 and cutting structures thereon, for lifting cuttings out of the wellbore 102 as it is being drilled, for controlling influx of fluids in the well, for maintaining the wellbore integrity, and for other purposes.

The BHA 106 may include the bit 110 or other components. An example BHA 106 may include additional or other components (e.g., coupled between to the drill string 105 and the bit 110). Examples of additional BHA components include drill collars, stabilizers, measurement-while-drilling (MWD) tools, logging-while-drilling (LWD) tools, downhole motors, underreamers, section mills, hydraulic disconnects, jars, vibration or damping tools, other components, or combinations of the foregoing. The BHA 106 may further include a directional tool 111 such as a bent housing motor or a rotary steerable system (RSS). The directional tool 111 may include directional drilling tools that change a direction of the bit 110, and thereby the trajectory of the wellbore. In some cases, at least a portion of the directional tool 111 may maintain a geostationary position relative to an absolute reference frame, such as gravity, magnetic north, or true north. Using measurements obtained with the geostationary position, the directional tool 111 may locate the bit 110, change the course of the bit 110, and direct the directional drilling tool 111 on a projected trajectory. For instance, although the BHA 106 is shown as drilling a vertical portion 102-1 of the wellbore 102, the BHA 106 (including the directional tool 111) may instead drill directional or deviated well portions, such as directional portion 102-2.

The directional portion 102-2 may be directed to a particular stratum 112 or group of strata 112. During well planning, the seismic surfaces generated by the seismic data may be used to generate a wellbore trajectory, or planned path for the wellbore. The trajectory of the directional portion 102-2 may be designed to stay within a certain proximity of a particular unconformity 113. The techniques of the present disclosure may be used to increase the accuracy of the seismic surface and maintain the directional portion 102-2 within the desired portion of the earth formation 101.

Examples of directional tools 111 and/or steering systems may include “push-the-bit” systems, “point-the-bit” systems, hybrid systems, any other system, and combinations thereof. In a push-the-bit system, actuator pads may extend from the directional tool 111 to contact the wellbore wall. The actuator pads may apply a force against the wellbore wall, which may push the bit away from the actuator pad. Other examples of push-the-bit systems may include RSS systems, non-rotating (with respect to the hole) eccentric stabilizers (e.g., displacement-based systems). Steering is achieved by creating non co-linearity between the drill bit and at least two other touch points.

In point-the-bit systems, the axis of rotation of the bit 110 is deviated from the local axis of the BHA 106 in the general direction of the desired path (target attitude). The borehole is propagated in accordance with the customary three-point geometry defined for example by upper and lower stabilizers and the hole reaming cutters. The angle of deviation of the drill bit axis coupled with a finite distance between the lower and middle touch points results in the non-collinear condition for a curve to be generated. This may be accomplished, for example, by a fixed bend at a point in the BHA 106 close to the lower stabilizer or flexure in the drill bit drive shaft distributed between the upper and lower stabilizers.

In general, the drilling system 100 may include additional or other drilling components and accessories, such as special valves (e.g., kelly cocks, blowout preventers, and safety valves). Additional components included in the drilling system 100 may be considered a part of the drilling tool assembly 104, the drill string 105, or a part of the BHA 106 depending on their locations in the drilling system 100.

In some embodiments, the BHA 106 may include a downhole motor to power for downhole systems and/or provide rotational energy for downhole components (e.g., rotate the bit 110, drive the directional tool 111, etc.). The downhole motor may be any type of downhole motor, including a positive displacement pump (such as a progressive cavity motor) or a turbine. In some embodiments, a downhole motor may be powered by the drilling fluid flowing through the drill pipe 108. In other words, the drilling fluid pumped downhole from the surface may provide the energy to rotate a rotor in the downhole motor. The downhole motor may operate with an optimal pressure differential or pressure differential range. The optimal pressure differential may be the pressure differential at which the downhole motor may not stall, burn out, overspin, or otherwise be damaged. In some cases, the downhole motor may rotate the bit 110 such that the drill string 105 may not be rotated at the surface, or may rotate at a different rate (e.g., slower) than the rotation of the bit 110.

The bit 110 in the BHA 106 may be any type of bit suitable for degrading downhole materials such as earth formation 101. Example types of drill bits used for drilling earth formations are fixed-cutter or drag bits, roller cone bits, and combinations thereof. In other embodiments, the bit 110 may be a mill used for removing metal, composite, elastomer, other downhole materials, or combinations thereof. For instance, the bit 110 may be used with a whipstock to mill into casing 107 lining the wellbore 102. The bit 110 may also be a junk mill used to mill away tools, plugs, cement, other materials within the wellbore 102, or combinations thereof. Swarf or other cuttings formed by use of a mill may be lifted to surface or may be allowed to fall downhole. In still other embodiments, the bit 110 may include a reamer. For instance, an underreamer may be used in connection with a drill bit and the drill bit may bore into the formation while the underreamer enlarges the size of the bore.

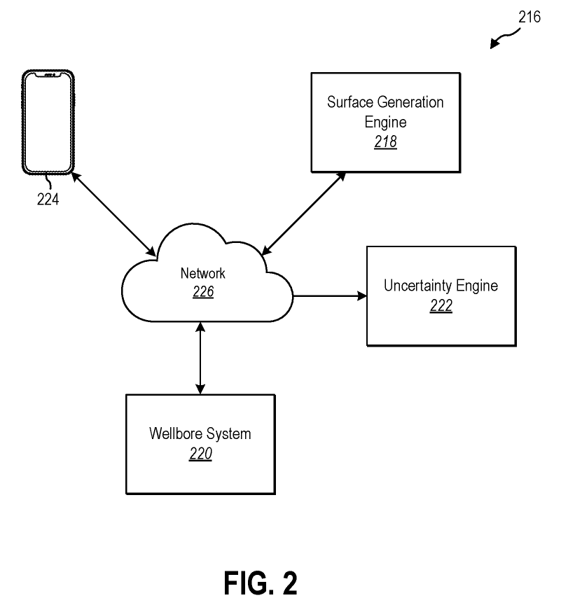

FIG. 2 is a representation of a seismic surface uncertainty system 216, according to at least one embodiment of the present disclosure. The seismic surface uncertainty system 216 includes a surface generation engine 218 that may generate a seismic surface of a geological feature at a wellbore system 220. The wellbore system 220 may generate or measure seismic data. The surface generation engine 218 may generate the seismic surface from the seismic data. In some embodiments, the wellbore system 220 may include a wellbore having a wellbore trajectory. In some embodiments, the wellbore system 220 may include a well planner having a planned wellbore trajectory.

As discussed in further detail herein, an uncertainty engine 222 may receive the seismic data from the wellbore system 220 and the seismic surface from the surface generation engine 218. The uncertainty engine 222 may generate an uncertainty for the seismic surface. The uncertainty may be locally calculated. For example, the seismic data may be provided in a grid, with each location on the grid including a seismic trace. The uncertainty for each location on the grid may be calculated based on the lag between the seismic trace at the position and the surrounding seismic traces on the grid.

For example, given a surface with ixj grid points, at each grid point of the surface the amplitudes of the seismic signal in a range of n values above and n values below the position of the surface point are extracted. The ixj arrays of size 2n+ 1 may be denoted as t_{i,j}. At each position (i, j) the lag between t_{i,j} and all t_{k,l} in a local horizontal radius of size o is calculated, where k = i-c and l = j-d with c and d element of [-o; o]. In the seismic resolution with a radius of o, the geology and thus the seismic signal is often relatively consistent. The radius o may be any value, including 1, 2, 3, 4, 5, 6, 7, 8, 9, or 10. The value of the radius o may be determined based on a known consistency or inconsistency of the geologic formation. In a consistent surface interpretation, all lags within the radius o may be zero or close to zero. An inconsistent surface interpretation may result in lags, based on of user or algorithmic error when interpreting the seismic signal. These lags are used to calculate the uncertainty.

Because the uncertainty engine 222 determines the uncertainty based on the lag between the target seismic trace and the surrounding seismic traces, the uncertainty engine 222 may determine the uncertainty agnostic of the surface generation methodology. For example, the uncertainty engine 222 may be completely separate from and/or independent of the surface generation engine 218. The uncertainty engine 222 may receive any seismic surface, agnostic of the surface generation engine 218 and the associated seismic surface methodology. Indeed, the uncertainty engine 222 may generate the uncertainty without changing an interpretation of the seismic surface, or without recalculating a position of the seismic surface at the target trace. Generating the uncertainty without changing the interpretation and/or without recalculating the position of the seismic surface may capture uncertainty in surface generation methodology, as well as uncertainty related to areas of low signal-to-noise ratio or other geology and/or measurement-related uncertainty.

The seismic surface and the uncertainty may be transmitted to a user device 224 over a network 226, such as the Internet. In some embodiments, the user device 224 may include a display, and a graphical representation of the seismic surface may be presented on a graphic user interface (GUI) of the display. The uncertainty of the surface may be presented as a graphical representation of the boundaries of the uncertainty boundaries on the GUI of the display with the seismic surface.

In accordance with at least one embodiment of the present disclosure, a user or drill planner may adjust a wellbore trajectory based on the determined uncertainty. For example, the user or drill planner may adjust the wellbore trajectory to stay away from the bounds of the uncertainty of the seismic surface. In some examples, the user or drill planner may adjust the wellbore trajectory to cross the seismic surface at a particular location based on the bounds of the uncertainty of the seismic surface.

The uncertainty may be used in any other underground process. For example, the uncertainty may be used to aid in the prediction of the geologic structure expected in front of a drilling bit in logging-while-drilling (LWD) applications. In some examples, the uncertainty may be used to determine well placement in future drilling campaigns. In some examples the uncertainty may be applied to geologic structures used when constructing geologic models. In some examples, the uncertainty may be applied to the geometry used in constructing reservoir flow models. In some examples, the uncertainty may be applied in an oil and gas production monitoring system. In some examples, the uncertainty may be used when monitoring changes in the surfaces for carbon Capture and sequestration (CCS). In this case the uncertainty in structural framework of the carbon dioxide storage reservoir may be used to assess quality of the interpretation of seismic data, acquired for monitoring purposes, to infer possible leakage paths, determine potential erosion of the cap overlaying the reservoir, assess accuracy of plume distribution, and so forth. In some examples, the uncertainty may be applied to the structural framework of a proposed reservoir for in CCS storage. The uncertainty is relevant to assess the evaluation of storage capacity and containment in CCS site characterization prior to the injection.

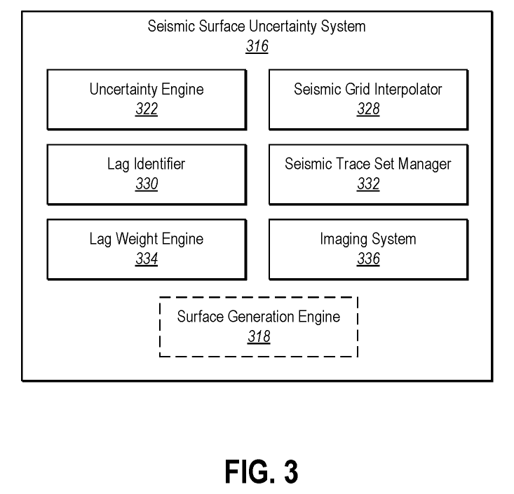

FIG. 3 is a representation of a seismic surface uncertainty system 316, according to at least one embodiment of the present disclosure. Each of the components of the seismic surface uncertainty system 316 can include software, hardware, or both. For example, the components can include one or more instructions stored on a computer-readable storage medium and executable by processors of one or more computing devices, such as a client device or server device. When executed by the one or more processors, the computer-executable instructions of the seismic surface uncertainty system 316 can cause the computing device(s) to perform the methods described herein. Alternatively, the components can include hardware, such as a special-purpose processing device to perform a certain function or group of functions. Alternatively, the components of the seismic surface uncertainty system 316 can include a combination of computer-executable instructions and hardware.

Furthermore, the components of the seismic surface uncertainty system 316 may, for example, be implemented as one or more operating systems, as one or more stand-alone applications, as one or more modules of an application, as one or more plug-ins, as one or more library functions or functions that may be called by other applications, and/or as a cloud-computing model. Thus, the components may be implemented as a stand-alone application, such as a desktop or mobile application. Furthermore, the components may be implemented as one or more web-based applications hosted on a remote server. The components may also be implemented in a suite of mobile device applications or “apps.”

The seismic surface uncertainty system 316 may receive a seismic surface and associated seismic data. As discussed herein, in some embodiments, the seismic surface uncertainty system 316 may optionally include a surface generation engine 318. The surface generation engine 318 may generate a seismic surface using seismic data. However, it should be understood that the seismic surface uncertainty system 316 may receive the seismic surface from an independent seismic surface generator, such as a third-party seismic surface generator and/or an in-house seismic surface generator unconnected to the seismic surface uncertainty system 316.

As discussed herein, seismic surface uncertainty system 316 may generate the seismic uncertainty independent of the surface generation engine 318. For example, the seismic surface uncertainty system 316 may generate the seismic uncertainty without recalculating a position of the seismic surface. In some examples, the seismic surface uncertainty system 316 may generate the seismic uncertainty without changing an interpretation of the seismic surface (e.g., without changing the position of the surface) at the target seismic trace. In some example, the seismic surface uncertainty system 316 may generate the uncertainty agnostic of the surface generation methodology, or without regard to the mechanism or methodology used to generate the seismic surface.

The seismic surface uncertainty system 316 may include an uncertainty engine 322. The uncertainty engine 322 may determine the uncertainty of the seismic surface based on the seismic surface and the seismic data. The uncertainty engine 322 may determine the uncertainty for a target trace. As discussed herein, the uncertainty engine 322 may individually determine the uncertainty for each seismic trace in the seismic data.

To determine the uncertainty, the seismic surface uncertainty system 316 may further analyze or process the seismic data. For example, a seismic grid interpolator 328 may re-grid each seismic trace. Re-gridding the seismic traces may include interpolating the seismic trace so that a datapoint of the seismic trace exactly intersects the seismic surface, rather than based on a pixel position of the surface. For example, the seismic surface may intersect a particular seismic trace between two datapoints on the seismic trace. The seismic trace may be interpolated to re-grid the data points to a higher resolution or a different resolution. This may facilitate easy and/or more accurate calculation of the lag between traces that are proximate to each other. The seismic grid interpolator 328 may re-grid the seismic traces in any manner, such as with a spline algorithm, cubic interpolation, nearest-neighbor interpolation, linear interpolation, polynomial interpolation, Chebyshev polynomials, mimetic interpolation, function approximation, gaussian process, any other interpolation mechanism, and combinations thereof. In some embodiments, for the subpixel exact lag estimation, a frequency correlation based approach is used in combination with the SI function that facilitates the determination of the lag sub-pixel exact on the fly.

In accordance with at least one embodiment of the present disclosure, a lag identifier 330 may identify or calculate the lag between a target seismic trace and a set of seismic traces that are proximate to the lag. A seismic trace set manager 332 may identify a set of seismic traces that surround the target seismic trace. For example, the seismic trace set manager 332 may identify an uncertainty radius in which the geology of the geologic formation mapped by the seismic surface is constant or relatively constant. The seismic trace set manager 332 may develop a set of seismic traces that are within this uncertainty radius. The set of seismic traces may be smaller than the total number of seismic traces in the seismic surface.

In some embodiments, the uncertainty radius is based on the interval between adjacent traces (crossline/inline sampling rate). The interval between adjacent traces may depend on the type of seismic and its processing. As a specific, non-limiting example, an inline interval may be 18.75 m and a crossline interval may be 12.5m. In some embodiments, an uncertainty radius of two traces may be used. This may result in an ellipse or rectangle when seen in meters, based on the difference in inline and crossline interval distances. In some embodiments, utilizing an uncertainty radius of two traces may provide sufficient data points to calculate reliable statistics.

In some embodiments, the uncertainty radius may be in a range having an upper value, a lower value, or upper and lower values including any of 1 m, 2 m, 5 m, 10 m, 15 m, 20 m, 25 m, 30 m, 40 m, 50 m, 75 m, 100 m, 125 m, or any value therebetween. For example, the uncertainty radius may be greater than 1 m. In another example, the uncertainty radius may be less than 50 m. In yet other examples, the uncertainty radius may be any value in a range between 1 m and 50 m. In some embodiments, it may be critical that the uncertainty radius is between 10 m and 20 m to generate an uncertainty that is reflective of short-range geologic consistency.

In some embodiments, the seismic trace set manager 332 may generate the set of seismic traces based on a trace offset, or a number of seismic traces away from the target seismic trace. In some embodiments, the trace offset may be in a range having an upper value, a lower value, or upper and lower values including any of 1, 2, 3, 4, 5, 6, 7, 8, 9, 10, or any value therebetween. For example, the trace offset may be greater than 1. In another example, the trace offset may be less than 10. In yet other examples, the trace offset may be any value in a range between 1 and 10. In some embodiments, it may be critical that the trace offset is between 1 and 3 to generate an uncertainty that is reflective of short-range geologic consistency.

In some embodiments, the seismic trace set manager 332 may generate the set of seismic traces using one or more subsamples of the seismic data. Subsamples of seismic data may include a sampling rate of datapoints in the seismic data that are generated at a higher resolution or sampling rate than the measurement frequency of the seismic data. This may result in additional datapoints to determine the uncertainty within the uncertainty rage. The subsamples may be generated in any manner, including a subsample exact estimation technique. In some embodiments, an interpolation technique may be utilized to generate the subsamples of the seismic data. In some embodiments, the subsample sampling rate may be in a range having an upper value, a lower value, or upper and lower values including any of 0.5 m, 0.6 m, 0.7 m, 0.8 m, 0.9 m, 1.0 m. 1.1 m, 1.2 m, 1.3 m, 1.4 m, 1.5 m, 2.0 m, 3.0 m, or any value therebetween. For example, the subsample sampling rate may be greater than 0.5 m. In another example, the subsample sampling rate may be less than 3.0 m. In yet other examples, the subsample sampling rate may be any value in a range between 0.5 m and 3.0 m. In some embodiments, it may be critical that the subsample sampling rate is between 0.5 m and 1.5 m to generate an uncertainty based on the surrounding seismic traces.

The lag identifier 330 may identify the lag between the target seismic trace and the seismic traces within the set of seismic traces. The lag may be the difference between the intersection of the target seismic trace at the seismic surface and the intersection of the offset seismic trace at the seismic surface. The lag identifier 330 may identify the lag between the target seismic trace and each seismic trace within the set of seismic traces.

The uncertainty engine 322 may use the lags between the target seismic trace and the set of seismic traces to determine the uncertainty at the target seismic trace. The uncertainty engine 322 may determine the uncertainty in any manner. For example, the uncertainty engine 322 may determine the uncertainty using a statistical analysis of the identified lags. In some embodiments, the statistical analysis may include determining the mean and standard deviation of the identified lags. The uncertainty engine 322 may utilize the mean and standard deviations of the lag to identify the uncertainty of the position of the seismic surface. The uncertainty engine 322 may generate the uncertainty having upper and lower boundaries bounded by the mean plus the desired number of standard deviations. For example, the uncertainty engine 322 may generate a 68% certain range based on the mean plus or minus one standard deviation, a 95% certain range based on the mean plus or minus two standard deviations, and a 99.7% certain range based on the mean plus or minus three standard deviations. In some embodiments, the uncertainty engine 322 may perform any other statistical analysis to identify the upper and lower boundaries of the uncertainty. For example, the uncertainty engine 322 may perform a median absolute deviation (MAD), or an interquartile range (IQR), provide a statistical distribution as a percentile (e.g., p5, p15, p50, p85, p95), any other statistical analysis, and combinations thereof.

As discussed herein, the seismic data may be arranged in a grid. As may be understood, different seismic traces in the grid surrounding the target seismic trace may have different distances from the target seismic trace. A lag weight engine 334 may assign a lag weight to a particular lag based on the distance of the lag from the target seismic trace. The lag weight may be assigned in any manner based on the distance from the target seismic trace, including a linear function, a square function, another polynomial function a parabolic function, an exponential function, any other function, and combinations thereof. Assigning the lag weight to the lags may improve the representation of the uncertainty, as the assumption of consistent geologic surface shape is less valid the further from the target seismic trace.

The uncertainty engine 322 may determine the uncertainty of the seismic surface at each seismic trace that intersects the seismic surface. Put another way, the uncertainty engine 322 may determine the uncertainty of the seismic surface at each seismic trace used to generate the seismic surface. For example, for each seismic trace, the seismic surface uncertainty system 316 may re-grid the seismic trace, determine the lag in the set of seismic traces, assign a lag weight to the lags, and calculate the uncertainty based on the weighted lags. Determining the uncertainty for each seismic trace of the seismic surface may cause the uncertainty to reflect changes in the seismic data and/or interpretation of the seismic surface.

In accordance with at least one embodiment of the present disclosure, the seismic surface uncertainty system 316 may include an imaging system 336 that may generate a graphical representation or image of the uncertainty boundaries surrounding the seismic surface. For example, the imaging system 336 may generate an image or graphical representation of the seismic surface. The imaging system 336 may identify the desired uncertainty boundaries (e.g., 68%, 95%, 99.7%). The uncertainty engine 322 may provide the imaging system 336 with the upper and lower uncertainty boundaries of the uncertainty. The imaging system 336 may plot the upper uncertainty boundary and the lower uncertainty boundary with the seismic surface. An operator or other user may view the graphical representation of the seismic surface with the upper uncertainty boundary and the lower uncertainty boundary. This may allow an operator to identify the seismic surface and plan or change a wellbore trajectory or other drilling operation based on the uncertainty of the seismic surface.

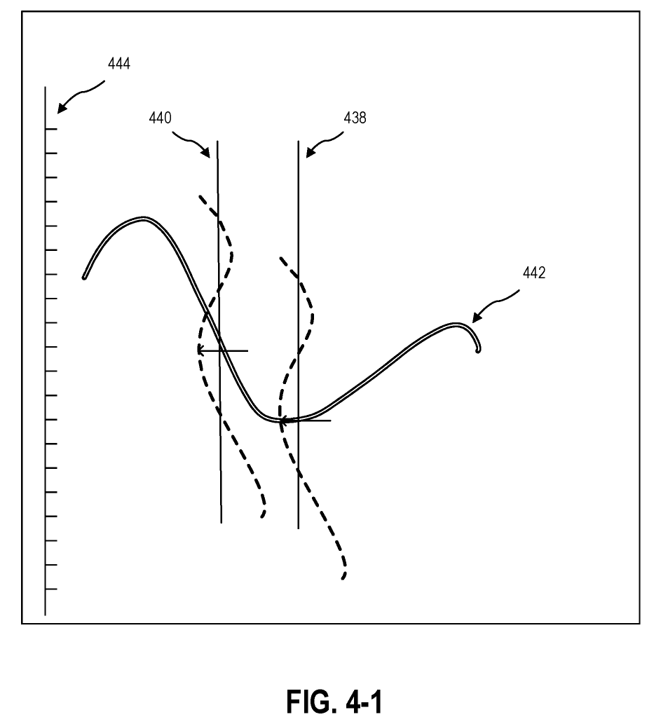

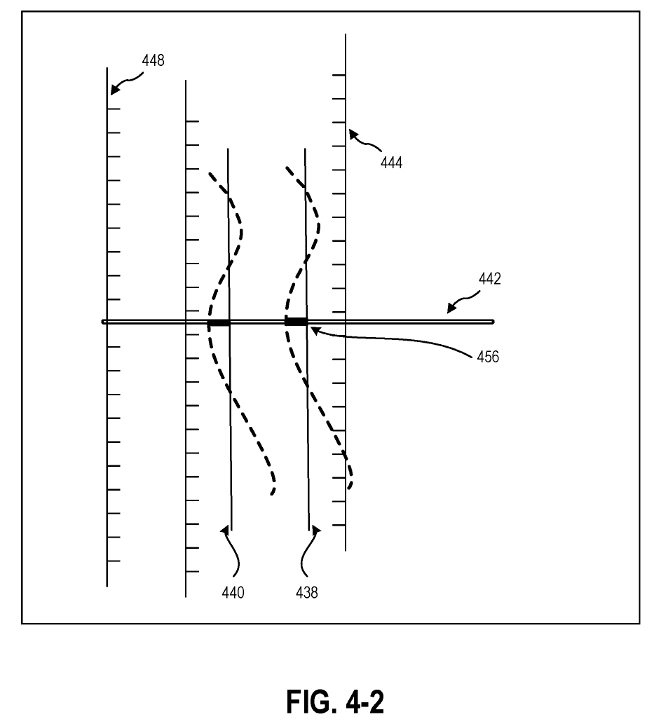

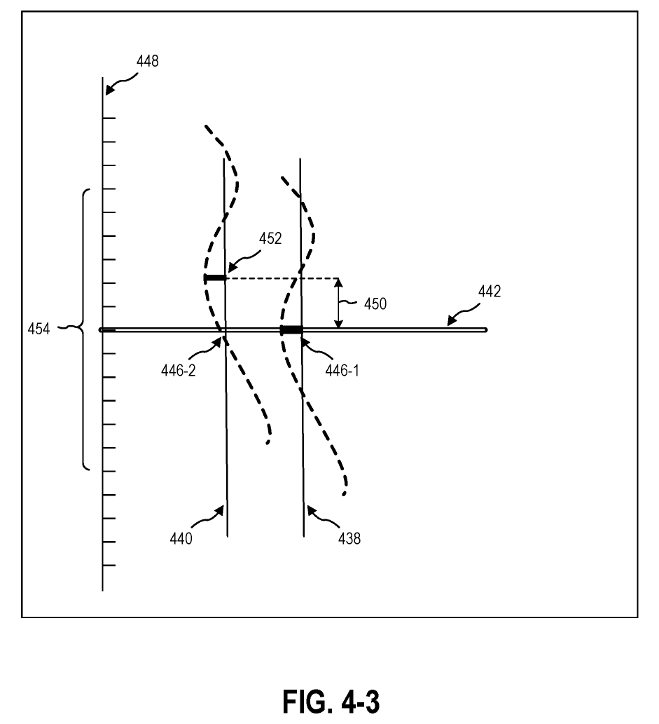

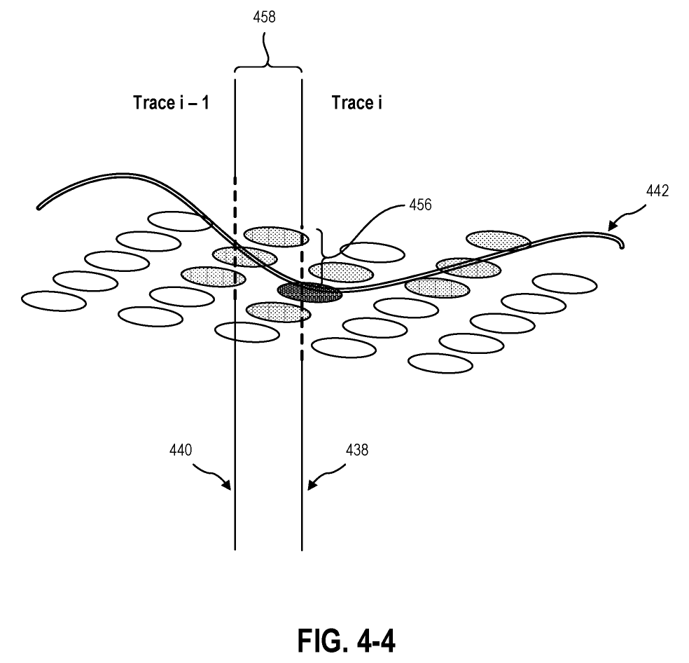

FIG. 4-1 through FIG. 4-4 are representations of the determination of uncertainty in a seismic surface, according to at least one embodiment of the present disclosure. In FIG. 4-1, a seismic surface uncertainty system is identifying the uncertainty between a target seismic trace 438 and an offset seismic trace 440. The target seismic trace 438 and the offset seismic trace 440 intersect a seismic surface 442. The target seismic trace 438 and the offset seismic trace 440 display a waveform that is mapped based on a seismic grid 444, which may be the resolution of the seismic traces.

In the view shown in FIG. 4-1, the seismic surface 442 is curved. In FIG. 4-2, the seismic surface 442 has been flattened for ease of illustration and analysis. The target seismic trace 438 and the offset seismic trace 440 may intersect the seismic surface 442 at an intersection point 446. As may be seen, for the target seismic trace 438 and the offset seismic trace 440, the intersection point 446 with the seismic surface 442 may be between data points on the seismic grid 444. As discussed herein, the seismic surface uncertainty system may re-grid the seismic grid 444 for the target seismic trace 438 and the offset seismic trace 440, resulting in an interpolated grid 448. In some embodiments, the seismic surface uncertainty system may generate the interpolated grid 448 for both the target seismic trace 438 and the offset seismic trace 440. In some embodiments, the seismic surface uncertainty system may generate a different interpolated grid 448 for the target seismic trace 438 and for the offset seismic trace 440.

In the embodiment shown, the target seismic trace 438 and the offset seismic trace 440 intersect the seismic surface 442 at the same location on their waveforms. Put another way, the target seismic trace 438 and the offset seismic trace 440 have zero lag between them.

In FIG. 4-3, the target seismic trace 438 is compared to a different offset seismic trace 440, which may be offset from the target seismic trace 438 in a different direction. The target seismic trace 438 has a first intersection point 446-1 and the offset seismic trace 440 has a second intersection point 446-2. The first intersection point 446-1 may be at a different location on the waveform of the target seismic trace 438 than the second intersection point 446-2. The seismic surface uncertainty system may identify a lag 450 between the first intersection point 446-1 and a corresponding point 452 on the offset seismic trace 440. As discussed herein, the lag 450 may be the distance between the first intersection point 446-1 and the corresponding point 452. The lag 450 may be identified or calculated based on the interpolated grid 448.

In some embodiments, the seismic surface uncertainty system may determine the lag using a sample range 454. The sample range 454 may be the range of the waveforms of the target seismic trace 438 and the offset seismic trace 440 used to determine the lag 450. The sample range 454 may include a single wave of the waveforms for comparison.

FIG. 4-4 is a perspective view of the seismic plots of FIG. 4-1 through FIG. 4-4. As discussed herein, the seismic surface uncertainty system may generate the uncertainty for the target seismic trace 438 based on the traces within an uncertainty radius. The uncertainty radius may be based on an uncertainty radius 456 from the target seismic trace 438. The seismic surface uncertainty system may determine the lag for all traces within the uncertainty radius 456. The distance between seismic traces (e.g., the distance between the target seismic trace 438 and the offset seismic trace 440) may be the offset radius 458.

As discussed herein, the distance between adjacent seismic traces may be different. The seismic surface uncertainty system may generate a lag weight based on the distance of the offset seismic trace 440 from the target seismic trace 438. In this manner, the resulting uncertainty may be representative of the difference in seismic surface interpretation of the surrounding seismic traces.

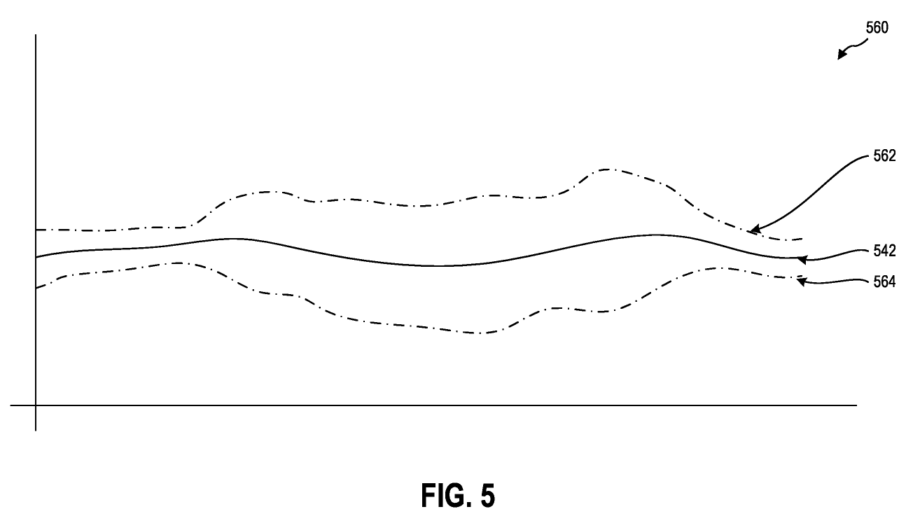

FIG. 5 is a representation of a seismic plot 560 of a seismic surface 542, according to at least one embodiment of the present disclosure. The seismic surface 542 may be the seismic surface generated by a third-party seismic surface generator and/or the seismic surface generated by an in-house seismic surface generator.

A seismic surface uncertainty system has determined the uncertainty of the seismic surface 542. As discussed herein, the seismic surface uncertainty system has generated an upper uncertainty boundary 562 and lower uncertainty boundary 564 of the seismic surface 542. The seismic surface uncertainty system may plot the seismic surface 542, the upper uncertainty boundary 562, and the lower uncertainty boundary 564 on a display or a GUI of the user device. This may provide a visual reference for the user to identify not only the location of the seismic surface 542, but the certainty of the location of the seismic surface 542. In areas where the upper uncertainty boundary 562 and the lower uncertainty boundary 564 are closer to the seismic surface 542, the uncertainty is lower. In areas where the upper uncertainty boundary 562 and the lower uncertainty boundary 564 are further from the seismic surface 542, the uncertainty is higher. This may allow a user or operator to generate a wellbore trajectory or plan another drilling operation with a reduced risk of entering or leaving a desired formation or other geologic feature illustrated by the seismic surface 542. For example, in geosteering processes, including automated geosteering, uncertainty can be used to determine plausible well trajectories in relation to nearby seismic surfaces. This uncertainty can be then used as a reference to define the deviated trajectory.

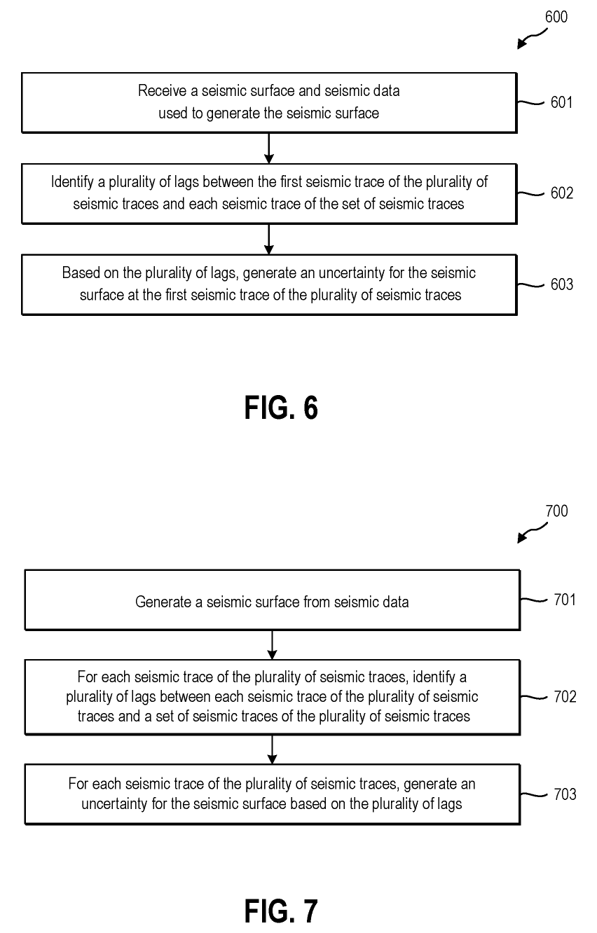

FIG. 6 and FIG. 7, the corresponding text, and the examples provide a number of different methods, systems, devices, and computer-readable media of the seismic surface uncertainty system. In addition to the foregoing, one or more embodiments can also be described in terms of flowcharts comprising acts for accomplishing a particular result, as shown in FIG. 6 and FIG. 7. FIG. 6 and FIG. 7 may be performed with more or fewer acts. Further, the acts may be performed in differing orders. Additionally, the acts described herein may be repeated or performed in parallel with one another or parallel with different instances of the same or similar acts.

As mentioned, FIG. 6 illustrates a flowchart of a series of acts or a method 600 for seismic surface uncertainty generation, according to at least one embodiment of the present disclosure. While FIG. 6 illustrates acts according to one embodiment, alternative embodiments may omit, add to, reorder, and/or modify any of the acts shown in FIG. 6. The acts of FIG. 6 can be performed as part of a method. Alternatively, a computer-readable medium can comprise instructions that, when executed by one or more processors, cause a computing device to perform the acts of FIG. 6. In some embodiments, a system can perform the acts of FIG. 6.

A seismic surface uncertainty system may receive a seismic surface and seismic data at 601. As discussed herein, in some embodiments, the seismic surface uncertainty system may receive the seismic surface from a third-party seismic surface generator. In some embodiments, the seismic surface uncertainty system may generate the seismic surface. The seismic data may include a plurality of seismic traces having a plurality of waveforms. The seismic surface may intersect each of the plurality of seismic traces. The seismic traces may include a first seismic trace (e.g., a target seismic trace, as discussed herein) and a set of seismic traces. The set of seismic traces includes each seismic trace located within an uncertainty radius of the first seismic trace.

The seismic surface uncertainty system may identify a plurality of lags between the first seismic trace and each seismic trace of the set of seismic traces at 602. The seismic surface uncertainty system may, based on the plurality of lags, generate an uncertainty for the seismic surface at the first seismic trace at 603.

As mentioned, FIG. 7 illustrates a flowchart of a series of acts or a method 700 for seismic surface uncertainty generation, according to at least one embodiment of the present disclosure. While FIG. 7 illustrates acts according to one embodiment, alternative embodiments may omit, add to, reorder, and/or modify any of the acts shown in FIG. 7. The acts of FIG. 7 can be performed as part of a method. Alternatively, a computer-readable medium can comprise instructions that, when executed by one or more processors, cause a computing device to perform the acts of FIG. 7. In some embodiments, a system can perform the acts of FIG. 7.

A seismic surface uncertainty system may generate a seismic surface from seismic data at 701. The seismic data includes a plurality of seismic traces having a plurality of waveforms. The seismic surface intersecting each of the plurality of seismic traces at the plurality of waveforms. For each seismic trace of the plurality of seismic traces, the seismic surface uncertainty system may identify a plurality of lags between each seismic trace of the plurality of seismic traces and a set of seismic traces of the plurality of seismic traces at 702. For each seismic trace of the plurality of seismic traces, the seismic surface uncertainty system generates an uncertainty for the seismic surface based on the plurality of lags at 703.

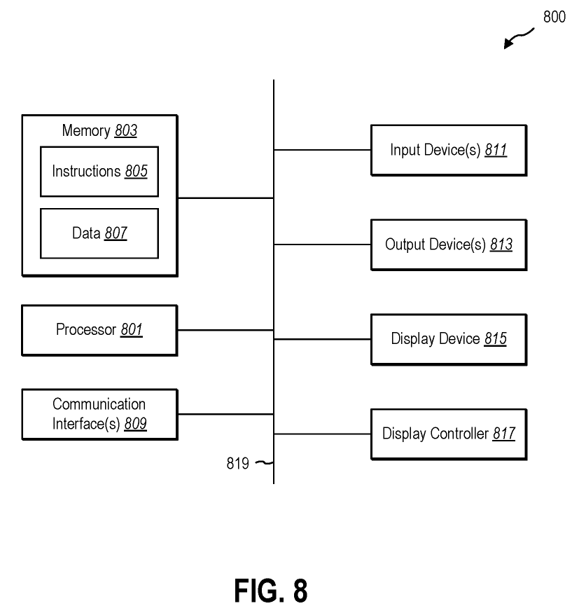

FIG. 8 illustrates certain components that may be included within a computer system 800. One or more computer systems 800 may be used to implement the various devices, components, and systems described herein.

The computer system 800 includes a processor 801. The processor 801 may be a general-purpose single or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 801 may be referred to as a central processing unit (CPU). Although just a single processor 801 is shown in the computer system 800 of FIG. 8, in an alternative configuration, a combination of processors (e.g., an ARM and DSP) could be used.

The computer system 800 also includes memory 803 in electronic communication with the processor 801. The memory 803 may be any electronic component capable of storing electronic information. For example, the memory 803 may be embodied as random access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM) memory, registers, and so forth, including combinations thereof.

Instructions 805 and data 807 may be stored in the memory 803. The instructions 805 may be executable by the processor 801 to implement some or all of the functionality disclosed herein. Executing the instructions 805 may involve the use of the data 807 that is stored in the memory 803. Any of the various examples of modules and components described herein may be implemented, partially or wholly, as instructions 805 stored in memory 803 and executed by the processor 801. Any of the various examples of data described herein may be among the data 807 that is stored in memory 803 and used during execution of the instructions 805 by the processor 801.

A computer system 800 may also include one or more communication interfaces 809 for communicating with other electronic devices. The communication interface(s) 809 may be based on wired communication technology, wireless communication technology, or both. Some examples of communication interfaces 809 include a Universal Serial Bus (USB), an Ethernet adapter, a wireless adapter that operates in accordance with an Institute of Electrical and Electronics Engineers (IEEE) 802.11 wireless communication protocol, a Bluetooth^{®} wireless communication adapter, and an infrared (IR) communication port.

A computer system 800 may also include one or more input devices 811 and one or more output devices 813. Some examples of input devices 811 include a keyboard, mouse, microphone, remote control device, button, joystick, trackball, touchpad, and lightpen. Some examples of output devices 813 include a speaker and a printer. One specific type of output device that is typically included in a computer system 800 is a display device 815. Display devices 815 used with embodiments disclosed herein may utilize any suitable image projection technology, such as liquid crystal display (LCD), light-emitting diode (LED), gas plasma, electroluminescence, or the like. A display controller 817 may also be provided, for converting data 807 stored in the memory 803 into text, graphics, and/or moving images (as appropriate) shown on the display device 815.

The various components of the computer system 800 may be coupled together by one or more buses, which may include a power bus, a control signal bus, a status signal bus, a data bus, etc. For the sake of clarity, the various buses are illustrated in FIG. 8 as a bus system 819.

The embodiments of the seismic surface uncertainty system have been primarily described with reference to wellbore drilling operations; the seismic surface uncertainty systems described herein may be used in applications other than the drilling of a wellbore. In other embodiments, seismic surface uncertainty systems according to the present disclosure may be used outside a wellbore or other downhole environment used for the exploration or production of natural resources. For instance, seismic surface uncertainty systems of the present disclosure may be used in a borehole used for placement of utility lines. Accordingly, the terms “wellbore,” “borehole” and the like should not be interpreted to limit tools, systems, assemblies, or methods of the present disclosure to any particular industry, field, or environment.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers’ specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that is within standard manufacturing or process tolerances, or which still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method for seismic uncertainty generation, the method comprising:
receiving a seismic surface and seismic data used to generate the seismic surface, the seismic data including a plurality of seismic traces having a plurality of waveforms, the seismic surface intersecting each of the plurality of seismic traces, the plurality of seismic traces including a first seismic trace and a set of seismic traces, the set of seismic traces including each seismic trace located within an uncertainty radius of the first seismic trace;
identifying a plurality of lags between the first seismic trace of the plurality of seismic traces and each seismic trace of the set of seismic traces; and
based on the plurality of lags, generating an uncertainty for the seismic surface at the first seismic trace of the plurality of seismic traces.

2. The method of claim 1, wherein the uncertainty is determined without recalculating a position of the seismic surface at the first seismic trace of the plurality of seismic traces.

3. The method of claim 1, wherein the uncertainty is determined without changing an interpretation of the seismic surface at the first seismic trace of the plurality of seismic traces.

4. The method of claim 1, wherein the uncertainty is determined agnostic of a surface generation methodology used to generate the seismic surface.

5. The method of claim 1, wherein generating the uncertainty includes applying a lag weight each lag of the plurality of lags based on a distance from the first seismic trace of the plurality of seismic traces.

6. The method of claim 1, wherein identifying the plurality of lags includes identifying the plurality of lags with a sampling rate that is greater than a resolution of the seismic data.

7. The method of claim 1, wherein the uncertainty radius is between 10 m and 20 m.

8. The method of claim 1, further comprising generating a graphical representation of the seismic surface, the graphical representation including the seismic surface and uncertainty boundaries based on the uncertainty.

9. The method of claim 1, further comprising adjusting a wellbore trajectory based on the uncertainty.

10. The method of claim 1, wherein the uncertainty is based on a mean and standard deviation of the plurality of lags.

11. A method for seismic uncertainty generation, the method comprising:
generating a seismic surface from seismic data, the seismic data including a plurality of seismic traces having a plurality of waveforms, the seismic surface intersecting each of the plurality of seismic traces at the plurality of waveforms;
for each seismic trace of the plurality of seismic traces, identifying a plurality of lags between each seismic trace of the plurality of seismic traces and a set of seismic traces of the plurality of seismic traces; and
for each seismic trace of the plurality of seismic traces, generating an uncertainty for the seismic surface based on the plurality of lags.

12. The method of claim 11, wherein the uncertainty is based on at least one of a mean and standard deviation of the plurality of lags, a median absolute deviation (MAD), or an interquartile range (IQR).

13. The method of claim 11, wherein the uncertainty is determined without recalculating the seismic surface.

14. The method of claim 11, wherein the uncertainty is determined agnostic of a surface generation methodology used to generate the seismic surface.

15. The method of claim 11, wherein the set of seismic traces is sized based on an uncertainty radius.

16. The method of claim 11, further comprising generating a graphical representation of the seismic surface, the graphical representation including the seismic surface and uncertainty boundaries based on the uncertainty.

17. The method of claim 11, wherein the set of seismic traces has a sampling rate that is greater than a resolution of the seismic data.

18. A system, comprising:
a processor and memory including instructions that cause the processor to:
receive a seismic surface and seismic data used to generate the seismic surface, the seismic data including a plurality of seismic traces having a plurality of waveforms, the seismic surface intersecting each of the plurality of seismic traces, the plurality of seismic traces including a first seismic trace and a set of seismic traces, the set of seismic traces including each seismic trace located within an uncertainty radius of the first seismic trace;
identify a plurality of lags between the first seismic trace of the plurality of seismic traces and each seismic trace of the set of seismic traces; and
based on the plurality of lags, generate an uncertainty for the seismic surface at the first seismic trace of the plurality of seismic traces.

19. The system of claim 18, wherein the uncertainty is determined agnostic of a surface generation methodology used to generate the seismic surface.

20. The system of claim 18, wherein generating the uncertainty includes applying a lag weight each lag of the plurality of lags based on a distance from the first seismic trace of the plurality of seismic traces.
